(19) United States
(12) Patent Application Publication
(10) Pub. No.: US 2024/0244585 A1
(43) Pub. Date: Jul. 18, 2024

(54) Re-evaluation of Sidelink Resources

(71) Applicant: Telefonaktiebolaget LM Ericsson (publ), Stockholm (SE)

(72) Inventors: Ricardo Blasco Serrano, Espoo (FI); Shehzad Ali Ashraf, Munich (DE); Jose Angel Leon Calvo, Aachen (DE); Jeong Hun Kim, Kanata (CA)

(21) Appl. No.: 18/290,229

(22) PCT Filed: May 10, 2022
(86) PCT No.: PCT/EP2022/062626

§ 371 Date: Nov. 10, 2023

Related U.S. Application Data
(60) Provisional application No. 63/187,143, filed on May 11, 2021.

(51) Int. Cl. H04W 72/02; H04W 28/26; H04W 72/40; H04W 72/563

(52) U.S. Cl. CPC H04W 72/02; H04W 28/26; H04W 72/40; H04W 72/563

(57) ABSTRACT

A method implemented by a transmitting user equipment. UE, configured for device-to-device, D2D, communication in a wireless communication network, wherein the transmitting UE is arranged to autonomously select resources for transmitting data received over a D2D communication link, the method comprising selecting, by the transmitting UE, a first resource for transmitting data to be received over the D2D communication link from a coordinating User Equipment, excluding, by the transmitting UE, the selected first resource based on at least one of obtaining, by the transmitting UE, additional information indicative of a conflict with the first resource, receiving, by the transmitting UE, from the coordinating UE, a control message comprising updated resources, subsequent to said excluding, re-selecting, by the transmitting UE, a second resource for transmitting said data to be received over the D2D communication link from said coordinating UE, performing, by the transmitting UE, said transmitting of said data using said second resource.

### TECHNICAL FIELD

The present disclosure relates generally to device-to-device (D2D) communications over sidelink (SL) resources and, more particularly, to resource selection and allocation for sidelink transmissions.

### BACKGROUND

The Third Generation Partnership Project (3GPP) specified support in Long Term Evolution (LTE) for proximity services (ProSe) in Release 12 (Rel-12) and Release 13 (Rel-13), targeting public safety use cases (e.g., first responders) as well as a small subset of commercial use cases (e.g., discovery). The main novelty of ProSe was the introduction of device-to-device (D2D) communications using the sidelink (SL) interface. During Release 14 (Rel-14) and Release 15 (Rel-15) in 3GPP, major changes were introduced to the LTE SL framework with the aim of supporting vehicle-to everything (V2X) communications, where V2X collectively denotes communication between vehicle and any other endpoint (e.g., a vehicle, a pedestrian, etc.). The feature targeted mostly basic V2X use cases such as day-1 safety, etc.

During Release 16 (Rel-16), 3GPP worked on specifying the sidelink interface for the Fifth Generation (5G) New Radio (NR). The NR sidelink in Rel-16 targets advanced V2X services, which can be categorized into four use case (UC) groups: vehicle platooning, extended sensors, advanced driving, and remote driving. Supporting the advanced V2X services required a new sidelink design in order to meet the stringent requirements in terms of latency and reliability. The NR sidelink in Rel-16 was designed to provide higher system capacity, increased reliability, and better coverage. In addition, the design considered the possibility of having future extensions to support further advanced V2X services and other related services.

The radio layers in LTE SL supported only broadcast communications. In contrast, the NR SL includes support in the radio layers for broadcast, multicast, and unicast communications. For example, in the platooning service, there are certain messages that are only of interest to the members of the platoon, making the members of the platoon a group. In another example known as the see-through use case, the most likely scenario involves only a pair of vehicles, for which unicast transmissions naturally fit. As in LTE SL, the NR SL is designed in such a way that its operation is possible with and without network coverage and with varying degrees of interaction between the user equipment (UEs) and the network (NW), including support for standalone, network-less operation.

3GPP usually refers to D2D transmissions as sidelink transmissions or transmissions using the PC5 interface. The applicable standards define two resource allocation modes for NR sidelink: network-based resource allocation and autonomous resource allocation.

In network-based resource allocation mode, the network selects the resources and other transmit parameters used by sidelink UEs. In some cases, the network may control every single transmission parameter. In other cases, the network may select the resources used for transmission but may allow the transmitter freedom to select some of the transmission parameters, possibly with some restrictions. In the context of NR SL, 3GPP refers to this resource allocation mode as Mode 1.

In autonomous resource allocation mode, the UEs autonomously select the resources and other transmit parameters. In this mode, there may be no intervention by the network (e.g., out of coverage, unlicensed carriers without a network deployment, etc.) or very minimal intervention by the network (e.g., configuration of pools of resources, etc.). In the context of NR SL, 3GPP refers to this resource allocation mode as Mode 2.

The network-based resource allocation mode (Mode 1) and autonomous resource allocation mode (Mode 2) in NR are analogous to Mode 3 and Mode 4 respectively in LTE.

### SUMMARY

The present disclosure provides methods and apparatus for inter-UE coordination in resource selection for sidelink communications. One aspect of the present disclosure comprises methods and apparatus for combining inter-UE coordination and additional sensing information to reduce the number of conflicts and latency in D2D communications. The techniques herein describe combine resource utilization information (e.g., sensing information, grants, resource suggestions, resource set, etc.) acquired by different nodes (e.g., UEs) and/or different times. The techniques help resolve situations in which resources selected using inter-UE coordination are later detected to be reserved by another UE and reduce the probability of collision in sidelink transmissions by re-evaluating the resources to be used for sidelink transmission.

In a first aspect of the present disclosure, there is provided a method implemented by a transmitting user equipment, UE, configured for device-to-device, D2D, communication in a wireless communication network, wherein the transmitting UE is arranged to autonomously select resources for transmitting data received over a D2D communication link, the method comprising: selecting, by the transmitting UE, a first resource, within a set of resources, for transmitting data to be received over the D2D communication link from a coordinating User Equipment; excluding, by the transmitting UE, the selected first resource based on at least one of: obtaining, by the transmitting UE, additional information indicative of a conflict with the first resource; receiving, by the transmitting UE, from the coordinating UE, a control message comprising updated resources; subsequent to said excluding, re-selecting/disregarding, by the transmitting UE, a second resource for transmitting said data to be received over the D2D communication link from said coordinating UE; performing, by the transmitting UE, said transmitting of said data using said second resource.

The inventors have found that, in case of an inter-UE coordination situation, the UE selecting the resources for transmission, for example the transmitting UE may miss information. For example, an inter-UE coordination message may be generated by the coordinating UE without some sensing information that is available at the transmitting UE. Another example is that an inter-UE coordination message may be generated and transmitted by the coordinating UE before some additional sensing information becomes available.

In the above described cases, the resource selection made by the transmitting UE may not be suitable for transmission. That is, it may be subject to an increased probability of collision or affected by half-duplex.

In other situations, a transmitting UE in an inter-UE coordination situation may lead to having contradictory information. For example, a UE may be suggested to select a resource for which it later predicts a high likelihood of collision.

The inventors have found that a situation may arise in which selected resources may no longer be the desired resources for transmitting data. This may, for example, be determined by obtaining, by the transmitting UE, additional information indicative of a conflict with the first resource and/or receiving, by the transmitting UE, from the coordinating UE, a control message comprising updated resources.

In accordance with the present disclosure, the wording “coordinating” UE is used throughout the specification. It is explicitly noted that a coordinating UE does not mean that this UE needs to have higher hierarchy/privileges compared to other UE. The coordinating UE may be any regular UE in the wireless communication network.

In an example, the transmitting UE may become aware of information that is relevant for future channel utilization. The information may indicate a potential conflict with the resource selected by the transmitting UE. The transmitting UE may then ignore its selected resource and may select an alternative resource for transmitting purposes.

In another example, the transmitting UE may select a first resource for transmission, and may use a second resource for transmitting a reservation for the first resource. Based on this transmission, the transmitting UE may receive a control message from any other UE indicating that there is a potential conflict with the first resource and/or suggestions for using alternative resources instead. Based on the received control message, the transmitting UE may disregard the first resource and may select an alternative resource for transmitting data.

In yet another example, the coordinating UE may provide the transmitting UE with a first grant, or a first suggestion, for resource to be used for transmitting data. The coordinating may then obtain additional information that may be relevant for future channel utilization. For example, the additional information may indicate a potential conflict with the first grant, or first suggestion, for resources. Subsequently, the coordinating UE may decide to sent another message to the transmitting UE with an updated grant, or updated suggestion, for resource to be used for transmitting data.

### BRIEF DESCRIPTION OF THE DRAWINGS

FIG. 1 illustrates an exemplary communication network supporting D2D communications.

FIG. 2 schematically illustrates inter-UE coordination.

FIG. 3 illustrates a first approach to inter-UE coordination between a coordinating UE (UE-A) and a transmitting UE (UE-B).

FIG. 4 illustrates a second approach to inter-UE coordination between a coordinating UE (UE-A) and a transmitting UE (UE-B).

FIG. 5 illustrates a third approach to inter-UE coordination between a coordinating UE (UE-A) and a transmitting UE (UE-B).

FIG. 6 illustrates a method implemented by a transmitting UE according to the first approach to inter-UE coordination.

FIG. 7 illustrates a method implemented by a transmitting UE according to the second approach to inter-UE coordination.

FIG. 8 illustrates a method implemented by a coordinating UE according to the second approach to inter-UE coordination.

FIG. 9 illustrates a method implemented by a transmitting UE according to the third approach to inter-UE coordination.

FIG. 10 illustrates a method implemented by a coordinating UE according to the third approach to inter-UE coordination.

FIG. 11 illustrates the main functional components of a UE configured for SL communications using inter-UE coordination as herein described.

### DETAILED DESCRIPTION

Referring now to the drawings, inter-UE coordination techniques according to the present disclosure will be described in the context of a wireless communication network implementing the NR communications standard. Those skilled in the art will appreciate, however, that the techniques are more generally applicable to any wireless communication networks supporting D2D communications over a sidelink interface.

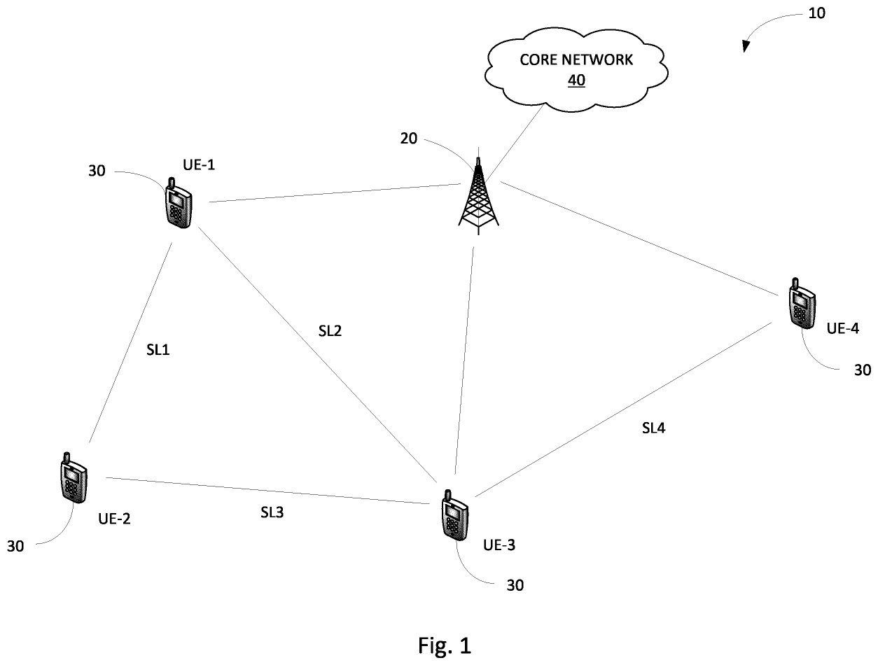

FIG. 1 illustrates a base station 20 that provides connection for a plurality of UEs 30 to a core network 40. Although a single base station 20 is shown in FIG. 1, those skilled in the art will appreciate that the wireless communication network 10 will typically include many base stations 20. The base stations 20 may also be referred to in the NR standards as Evolved Node Bs (eNBs), 5G Node Bs (gNBs) or Next Generation eNBs (ng-eNBs).

UE-1-UE-4 are capable of D2D communications over a sidelink (e.g., PC5 interface) with other UEs 30 in their proximity. UE-1, UE-3 and UE-4 are within network coverage while UE-2 is outside network coverage. UE-1 is in the proximity of UE-2 and UE-3 and can communicate over sidelinks SL1 and SL2 with UE-2 and UE-3 respectively. UE-2 is in the proximity of UE-1 and UE-3 and can communicate over sidelinks SL1 and SL3 with UE-1 and UE-3 respectively. UE-3 is in the proximity of UE-1, UE-2 and UE-4 and can communicate with them respectively over the sidelinks SL2, SL3, and SL4. Finally, UE-4 is in the proximity of UE-3 and can communicate over sidelink SL4. UE-4, however, is outside the range of UE-1 and UE-2 and is unable to establish a direct connection with UE-1 or UE-2 over a sidelink. UE 4 could communicate with UE-1 via base station 20. UE-2, however, is outside the coverage of the base station 20.

One aspect of the disclosure comprises techniques for autonomous resource allocation for SL transmissions using inter-UE coordination. The 3GPP standards define two resource allocation modes for NR sidelink: network-based resource allocation and autonomous resource allocation. In network-based resource allocation mode, referred to as Mode 1, the network selects the resources and other transmit parameters used by sidelink UEs. In some cases, the network may select the resources used for transmission but allow the UE 30 freedom to select some of the transmission parameters, possibly with some restrictions. In autonomous resource allocation mode, referred to as Mode 2, the UEs 30 autonomously select the resources and other transmit parameters. In this mode, there is typically no intervention by the network or very minimal intervention by the network (e.g., configuration of pools of resources, etc.).

In SL transmission mode 2, distributed resource selection is employed, i.e., there is no central node for scheduling and resources are autonomously selected by the UEs 30. Transmission Mode 2 is based on two functionalities: reservation of future resources and sensing-based resource allocation. Reservation of future resources is done so that the UE 30 sending a message can notify the receivers about its intention to transmit using certain time-frequency resources at a later point in time. For example, a UE 30 transmitting at time T informs the receivers that it will transmit using the same frequency resources at time T+100 ms. Resource reservation allows a receiving UE 30 to predict the utilization of the radio resources in the future. That is, by listening to the current transmissions of another UE, it also obtains information about potential future transmissions. This information can be used by the UE 30 to avoid collisions when selecting its own resources. Specifically, a UE 30 predicts the future utilization of the radio resources by reading received booking messages and then schedules its current transmission to avoid using the same resources. This is known as sensing-based resource selection.

Generally, sensing can be described as monitoring slots in a sidelink resource pool from which resources are selected. Sensing can be performed over a defined window. The sensing-based resource selection scheme specified in NR Rel-16 can be roughly summarized in the following steps as defined in clause 8.1.4 in TS 38.214.
A UE 30 senses the transmission medium during an interval [n-a, n-b], where n is a time reference, and a>b>0 define the duration of the sensing window. The length of the sensing window is (pre-) configurable. Sensing the transmission medium comprises, inter alia, receiving transmissions of control information indicating reservations of resources and/or performing measurements. The UE 30 may exclude some time slots from the interval [n−a, n−b] in some cases (e.g., slots in which the transmissions of UE 30 occur, etc.).
Based on the sensing results, the UE 30 predicts the future utilization of the transmission medium at a future time interval [n+T1, n+T2], where T2>T1>0. The interval [n+T1, n+T2] is the resource selection window.
The UE 30 selects one or more time-frequency resources among the resources in the selection window [n+T1, n+T2] that are predicted/determined to be selectable (e.g., idle, usable, available, etc.).

The approach to autonomous resource allocation described above aims at predicting future utilization of the channel and selecting resources to avoid collisions. However, collisions may be detected after the initial allocation of resources. As one example, after selecting a resource, but prior to performing any transmission (i.e., prior to reserving any of the selected resource), the UE 30 may detect through sensing a potential collision affecting one of the selected resources. Note that the initial selection of resources made a UE 30 is an internal decision, unknown to nearby UEs. At this point we say the resource is selected (but not reserved). After transmitting a reservation for a selected resource, the surrounding UEs 30 become aware of this condition. At this point the resource is deemed to be reserved (or selected and reserved). As another example, after reserving a resource, a UE 30 may sense a conflicting reservation transmitted by another UE 30. Which of the two reservations has precedence (if any) can be determined by looking at the priority associated with each of them. This information is signaled together with the reservation.

Two mechanisms are available to avoid collisions in the preceding two situations: re-evaluation (or re-evaluation and re-selection) for the case that a resource is selected but not reserved and pre-emption (and re-selection) for the case that a resource is selected and reserved.

In the case of re-evaluation, other UEs 30 may reserve the same resources in the time lapse between the selection of the resource(s) and the transmission of a corresponding reservation. To avoid such a collision, a UE 30 is allowed to re-consider its selection. The purpose of such procedure is to evaluate if the earlier selected resource(s) are still suitable for transmission or not. If a UE 30 determines that the earlier selected resource(s) is (are) no longer suitable for its own transmission (e.g., some other UE 30 also selected the same resource in the meantime), it triggers the resource selection mechanism again. In this case, a new set of candidate resources is created, and the resource(s) is(are) randomly selected from the newly created candidate resource set. This procedure is referred to as re-evaluation or re-evaluation and re-selection.

In the pre-emption case, after a reservation has been sent, the UE 30 cannot re-evaluate its selection. However, it may be prevented from transmitting if other UEs 30 have higher priority transmissions to perform. In these cases, known as pre-emption, a UE 30 (re-)triggers the resource selection if another UE 30 with higher priority selects the same resource for its transmission. In this case, a UE 30 with low priority transmission (re-)triggers resource selection and a new set of candidate resource set is created/determined by the UE 30 based on the recent sensing information. This procedure is referred to as pre-emption or pre-emption and re-selection.

In Release-17 (Rel-17), 3GPP is working on multiple enhancements for the sidelink with the aim of extending the support for V2X and to cover other use cases (UCs) such as public safety (see RP-202846). Improving the performance of power limited UEs 30 (e.g., pedestrian UEs, first responder UEs, etc.) and improving the performance using resource coordination are considered two of the main goals of this release. One feature under consideration is inter-UE coordination In one scenario under consideration, a first UE 30 denoted UE-A determines a set of resources and sends the set of resources to UE-B. UE-B takes the resources indicated by UE-A into account in the resource selection for its own transmission. The information sent from UE-A to UE-B is referred to as inter-coordination information.

Different approaches to inter-coordination are being considered. In one approach, referred to as Scheme 1, the inter-coordination information comprises the set of resources preferred and/or non-preferred for UE-B's transmission. In another approach, referred to as Scheme 2, the coordination information sent from UE-A to UE-B comprises the presence of expected/potential and/or detected resource conflicts on the resources indicated by UE-B's sidelink control information (SCI). When UE-B receives the inter-UE coordination information from UE-A, UE-B's selection or re-selection of a resource for its own transmission can be based on both UE-B's sensing result (if available) and the received coordination information, or can be based on the received coordination information only. In some scenarios, the received coordination information is used for the initial selection of a resource. In other, the received coordination information is used for re-selection of a resource.

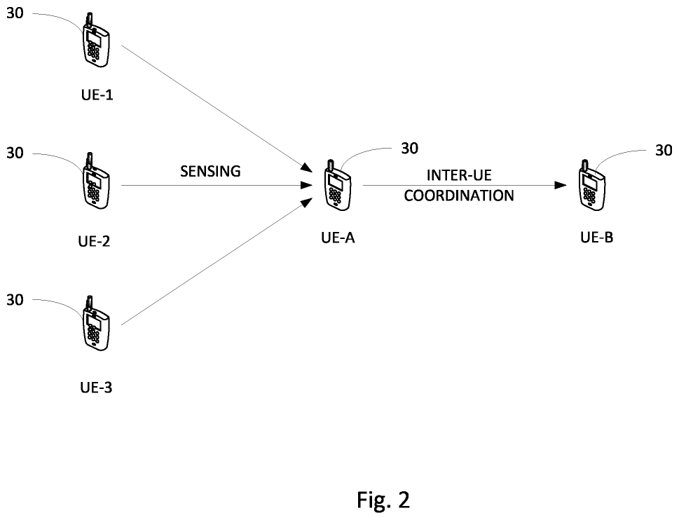

FIG. 2 illustrates one example of inter-UE coordination. In this example, UE-A gathers some information through sensing the transmissions by UE-1, UE-2, and UE-3. UE-A uses the information to provide resources to UE-B that may be suitable for transmission by UE-B. For example, the resources provided by UE-A can be used by UE-B to perform its own transmission.

When using inter-UE coordination, a UE 30 selecting resources for transmission (i.e., UE-B in the above example) may miss some essential information. For example, an inter-UE coordination message may be generated by UE-A without some sensing information that is available at UE-B. Also, an inter-UE coordination message may be generated and transmitted by UE-A before some additional sensing information becomes available. In these scenarios, the resource selection made by UE-B may not be suitable for transmission. That is, it may be subject to a high probability of collision or affected by half-duplex. In some scenarios, the inter-UE coordination may lead to contradictory information. For example, a UE 30 may be suggested to select a resource for which it later predicts a high likelihood of collision.

One aspect of the present disclosure comprises methods and apparatus for combining inter-UE coordination and additional sensing information to reduce the number of conflicts and latency in D2D communications. The techniques herein describe enable combining resource utilization information (e.g., sensing information, grants, etc.) acquired by different nodes (e.g., UEs) and/or different times. The techniques help resolve situations in which resources selected using inter-UE coordination are later detected to be reserved by another UE 30 and reduce the probability of collision in sidelink transmissions by re-evaluating the resources to be used for sidelink transmission.

A common theme of the methods herein described is that resources are selected for a data transmission (for itself, granted to others, etc.) using inter-UE coordination. Later, new information about the availability of the resources is acquired. Based on the newly received and/or acquired information, the suitability of the selected resources is reconsidered. Eventually, new resources may be selected and others dropped. Different actions may be performed by different UEs.

The inter-UE coordination techniques are described in the context of 3GPP sidelink, where UEs 30 (operating either of the SL modes described earlier) communicate directly with each other, without sending the information through the base station 20. However, the techniques are more generally applicable beyond sidelink so far as a UE 30 can obtain a grant (e.g., by itself, from another UE, a base station, etc.) and based on some information about the channel (e.g., acquired through sensing, transmitted from another node, etc.) determine whether none/some/all of the resources can be used or some other resources must be selected. In the following discussion, UE-A transmits an inter-UE coordination message to UE-B, and UE-B selects resources for performing a transmission.

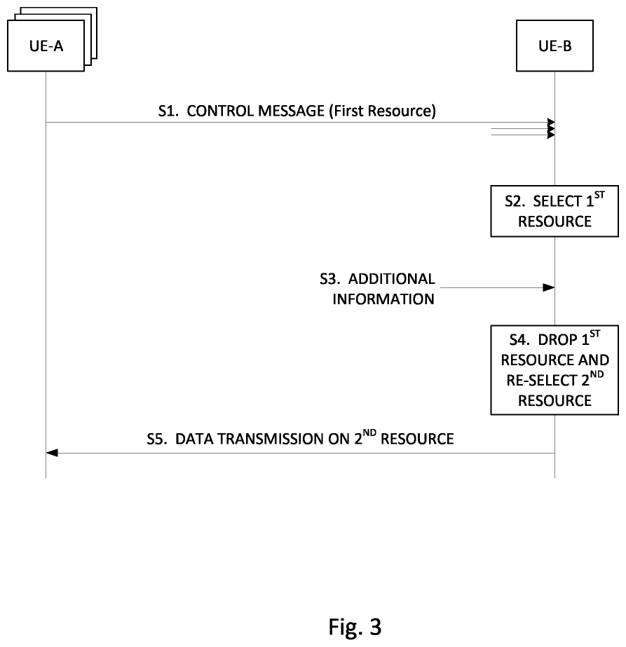

In a first approach to inter-UE coordination, the re-evaluation and pre-emption framework is used to reconsider the use of some resources that have been previously granted to UE-B. In this approach, a UE 30 is provided a first resource by a grant or other control message and later, after obtaining more information about the channel or another grant, it drops the selected resource and selects a second resource. Excluding the selected resource may comprise, for example, discarding a previous selection of the resource, if the resource has been selected, or removing the resource(s) from the corresponding sidelink grant (sometimes referred to as the selected sidelink grant). FIG. 3 illustrates an embodiment of this approach comprising the following steps:
Step S1: UE-A sends a control message (e.g., grant) to UE-B including a first resource for a data transmission. UE-B receives the control message.
Step S2: UE-B optionally selects the first resource.
Step S3: UE-B obtains additional information relevant to future channel utilization. The information indicates a potential conflict with the resource provided by the control message/grant.
Step S4: UE-B discards (i.e., drops) the first resource indicated/granted in Step S1 and selects/re-selects a second resource for transmission.
Step S5: UE-B performs a transmission in the second resource selected in Step S4.

### Variations of Step S1

In one embodiment, the control message from UE-A comprises a grant. The grant may specify one or more resource for UE-B's data transmission. The resources may be listed in priority order.

In one embodiment, UE-B receives multiple control messages/grants, each from a different UE 30. Each of the UEs 30 providing a grant is termed as UE-A in this context.

In one embodiment, UE-B determines a resource which is common in all the received control messages/grants. Resource determination can either be in terms of available/preferred or non-available/non-preferred resource.

In one embodiment, UE-B determines a resource which is common to the maximum number of the received control messages/grants. Resource determination can either be in terms of available/preferred or non-available/non-preferred resources.

In one embodiment, UE-B selects randomly among one of the received control messages/grants. In some cases, this can be conditioned on the number or percentage of resources determined as available considering all the received control messages/grants. Resource determination can either be in terms of available/preferred or non-available/non-preferred resources.

In one embodiment, UE-B selects a resource in the latest of all the received control messages/grants. In some cases, this can be conditioned on the number or percentage of resources determined as available considering all the received control messages/grants. Resource determination can either be in terms of available/preferred or non-available/non-preferred resources.

In one embodiment, UE-B selects among the received control messages/grants, the control messages/grants associated with the highest hierarchy/ranked UE, e.g., a Road Side Unit (RSU) node or relay UE.

In one embodiment, UE-B selects among the received control messages/grants, the control messages/grants associated with a UE-A to which a previous enquiry from UE-B has been sent, i.e., UE-B requested a control messages/grants from a specific UE-A.

In one embodiment, the control messages/grants is provided by a network node such as a base station 20 (e.g., an eNB, gNB, etc.).

### Variations of S3.

In one embodiment, the additional information is obtained by the UE 30 by means of sensing.

In one embodiment, the additional information is obtained by the UE 30 from a control messages/grants.

In one embodiment, obtaining the additional information comprises performing measurements (e.g., physical layer measurements).

In one embodiment, the additional information consists of a reservation transmitted by another UE. The reservation is for the same resource that is provided by the control messages/grants in Step S1. For example, the additional information may consist of control information transmitted by another UE 30 using a physical layer (PHY) signaling (e.g., first stage SCI) or higher layer signaling (e.g., a Medium Access Control-Control Element (MAC CE) or PC5-Radio Resource Control (RRC) signaling).

In one embodiment, the first resource is a resource reserved by UE-B (e.g., UE-B has already transmitted a reservation for the resource). That is, between Step S2 and Step S3, UE-B reserves the granted resource. In this case, excluding a reserved resource may be referred to as pre-emption.

In another embodiment, the first resource is a resource that is not reserved by UE-B (e.g., UE-B may have selected the resource but not reserved it (yet) by transmitting a reservation, or UE-B may have been granted the resource but not reserved it (yet) by transmitting a reservation). In this case, excluding an unreserved resource may be referred to as re-evaluation or re-evaluation and re-selection.

In embodiment, the potential conflict with the resources provided by the control messages/grants consists of a collision (i.e., the same resource is reserved by another UE).

In embodiment, the potential conflict with the resources provided by the control messages/grants consists of a half-duplex situation (i.e., two UEs 30 transmitting at the same time while being the destination of each other's transmissions).

### Variations of Step S4

In one embodiment, UE-B performs a transmission in response to excluding the resource. For example, UE-B may perform a transmission to indicate that it drops the resource, or UE-B may perform a transmission to request further resources.

In one embodiment, UE-B selects a new resource from a control message/grant provided by another UE 30 or network node. The resource may be part of the control message/grant from Step S1 or from another control message/grant (e.g., obtained in response to excluding the resource).

In one embodiment, UE-B selects a new resource from a control message/grant provided by the same UE 30 (i.e. the UE-A) but in later point in time.

In one embodiment, UE-B selects a new resource based on its own sensing information.

In one embodiment, UE-B selects a new resource based on its own sensing information and inter-UE coordination messages received from another UEs.

In one embodiment, the UE discards a selection of the first resource and selects a second resource for a data transmission.

In one embodiment, the UE removes the first from a selected grant and selects a second resource from the remaining resources.

In one embodiment, the UE notifies higher layer protocols (e.g., Radio Resource Control (RRC) when it drops the first resource and/or re-selects the second resource.

### Variations of Step S5

In one embodiment, the transmission comprises control information reserving a further resource for a (potential) transmission in the future.

In a second approach to inter-UE coordination, additional sensing capabilities at UE-A is used to provide alternative resources for transmission to UE-B whenever its selection is determined to be affected by a potential collision. In this approach, a UE 30 first selects a resource for its own transmission and later, after receiving an inter-UE coordination message, it discards or drops the selected resource and selects a second resource.

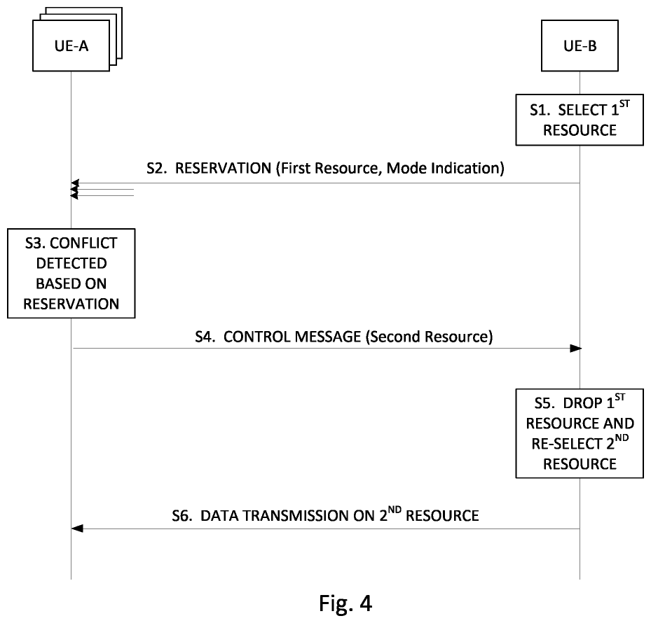

FIG. 4 illustrates an embodiment of this approach comprising the following steps:
Step S1: UE-B selects a first resource for transmission using a first mode of resource selection.
Step S2: UE-B transmits a reservation for the first resource. The reservation is received by UE-A. The reservation optionally includes an indication of a first mode of resource selection.
Step S3: Based on the transmission received from UE-B, UE-A determines that the reserved resource is subject to a likely collision.
Step S4: UE-A transmits a control message (e.g., grant) to UE-B. The control message/grant comprises one or more resources for the data transmission. UE-B receives the control message from UE-A.
Step S5: UE-B discards (i.e., drops) the first selected resource and selects a second resource indicated in the control message/grant.
Step S6: UE-B performs a transmission in the second resource.

In one embodiment, the indication of a first mode of resource selection in the reservation transmitted in step S2 comprises an indication that the resource selection mode uses a reduced amount of sensing results. For example, it may indicate that the resource was randomly selected or using partial sensing information (e.g., using a reduced amount of sensing results).

In one embodiment, the control message in step S4 is an inter-UE coordination message. The control message could be sent using physical layer (PHY) signaling, a MAC CE, RRC signaling, etc.

In one embodiment, a first mode of resource selection in the reservation transmitted in step S2 comprises full sensing-based resource selection.

In one embodiment, the resources comprised in the control message (S4) are part of a control message/grant. In one embodiment, the UE-B uses the resources provided in the control messages/grants in the order provided in the control message/grant, without the possibility of selecting other resources.

In one embodiment, the resources comprised in the control message/grant (S4) are a list of suggested resources, e.g., preferred/non-preferred resources. UE-B can select which resources to use among those in the list (S4), or even select resources that are not in the provided list.

In a third approach to inter-UE coordination, the use of the re-evaluation and pre-emption framework is extended to allow UE-A to reconsider the resources provided to UE-B in an earlier inter-UE coordination message. This approach is different from the preceding two approaches in that UE-A takes the responsibility of granting resources to UE-B as well as performing re-evaluation and reselection and/or pre-emption.

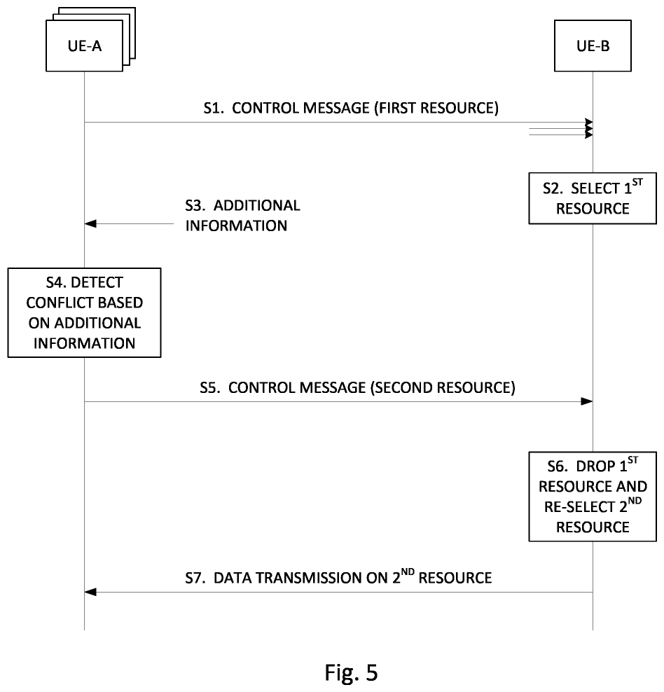

FIG. 5 illustrates an embodiment of this approach comprising the following steps:
Steps S1 & S2: UE-A sends first control message (e.g. grant) to UE-B indicating a first resource for transmission. UE-B selects first resource.
Step S3 & S4: UE-A obtains information relevant to future channel utilization. Based on the additional information, UE-A determines a potential conflict with the first resource provided by the control message/grant.
Step S5: UE-A provides a second control message/grant to UE-B indicating a second resource for transmission.
Step S6: Upon receiving the second control message/grant, UE-B discards the first resource and re-selects the second resource.
Step S7: UE-B transmits using the second resource.

### Variations in Step S1 & S2.

In one embodiment, the first control message/grant includes potential resources for second control message/grant from UE-A to UE-B.

### Variations in Step S3 & S4.

In one embodiment, the information is obtained by the UE 30 by means of sensing.

In one embodiment, the information is obtained by the UE 30 in the form of grant from other UEs.

In one embodiment, the operation performed in Step S4 consists of using the re-evaluation mechanisms. For example, UE-A may transmit in Step S1 a control message/grant for a first resource to UE-B. Prior to that resource, UE-A may detect a potential collision (using the rules for re-evaluation). This may trigger Step S5.

In one embodiment, the operation performed in Step S3 and S4 consists of using the pre-emption mechanisms. For example, UE-A may transmit in Step S1 a control messages/grants for a first resource and a third resource to UE-B. UE-B makes use of the third resource for a first transmission, reserving the first resource for a later transmission. After this, UE-A may detect a potential collision (using the rules for pre-emption) concerning the first resource. This may trigger Step S5.

In one embodiment, obtaining the information comprises performing measurements (e.g., physical layer measurements).

In one embodiment, the information consists of a reservation transmitted by another UE. The reservation is for the same resource that is provided by the control messages/grants in Step S1. For example, the information may consist of control information transmitted by another UE 30 using a SCI (e.g., first stage SCI) or higher layer signaling (e.g., a MAC CE or PC5-RRC signaling).

### General Considerations

Embodiments described for one approach in this disclosure may be applicable for other approaches in the disclosure. For example:
The signaling used to convey control signaling (PHY, MAC CE, PC5-RRC).
Control signaling comprising inter-UE coordination messages.
Detecting a conflict comprising detecting a potential collision or a potential half-duplex situation.
Sensing comprising measurements and/or receiving control information transmitted by others.
Inter-UE coordination messages being grants and/or suggested resources
Whether a resource to be dropped is already reserved or not. That is, whether the resource is pre-empted or just re-evaluated.

The different aspects of the method may be configured by a network node or be part of a pre-configuration in the device (e.g., in the subscriber identity module (SIM)).

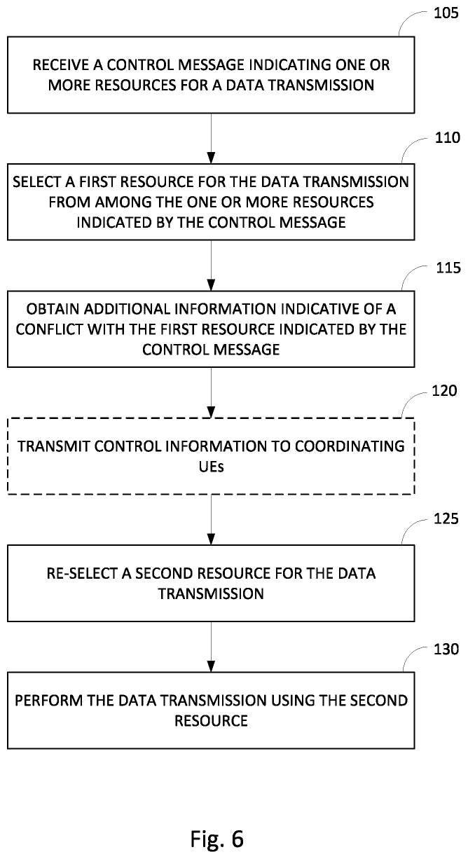

FIG. 6 illustrates an exemplary method 100 of inter-UE coordination implemented by a transmitting UE 30 (UE-B in the above examples). The transmitting UE 30 receives a control message from a coordinating UE 30 indicating one or more resources for a data transmission and selects a first resource from among the one or more resources indicated by the control message (blocks 105 and 110). The transmitting UE 30 thereafter obtains additional information indicative of a conflict with the first resource (block 115). Based on the additional information, the transmitting UE 30 may optionally transmit control information to coordinating UEs 30 (block 120). The control information may, for example, indicate that the first resource was dropped or may request new resources for the transmission. The transmitting UE 30 then re-selects a second resource for the data transmission and performs the data transmission using the second resource (block 125, 130).

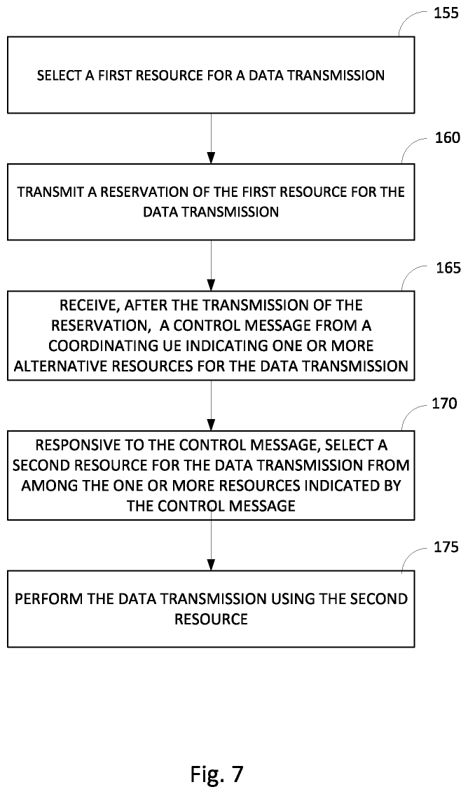

FIG. 7 illustrates an exemplary method 150 of inter-UE coordination implemented by a transmitting UE 30 (UE-B in the above examples). The transmitting UE 30 selects a first resource for a data transmission and transmits a reservation of the first resource for the data transmission (block 155, 160). After the transmission of the reservation, the transmitting UE 30 receives a control message from a coordinating UE 30 indicating one or more resources relevant for resource selection (block 165). Responsive to the control message, the transmitting UE 30 selects a second resource for the data transmission and performs the data transmission using the second resource (block 170, 175).

In some embodiments, the control message indicates alternative resources for the data transmission and the transmitting UE 30 selects the second resource from among the one or more alternative resources indicated by the control message. The alternative resources may overlap with resources indicated in the first control message or may represent all new resources. In other embodiments, the control message indicates non-preferred/non-allowed resources for the data transmission and the transmitting UE 30 selects a resource not included in the control message. In this case, the transmitting UE 30 may select a resource indicated in the first control message as the second resource. Also, the transmitting UE may select a resource in a control message from a different coordinating UE as the second resource.

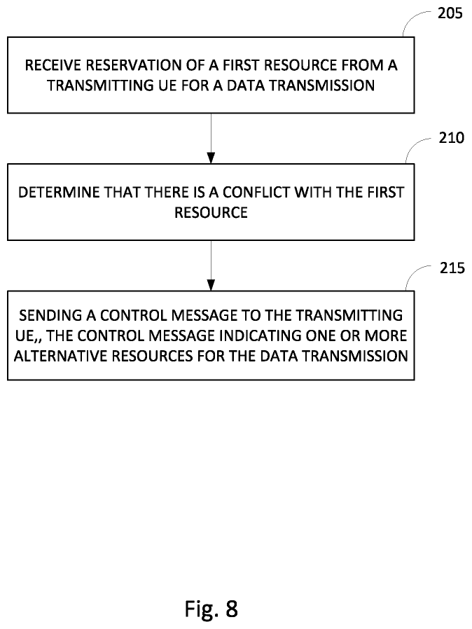

FIG. 8 illustrates an exemplary method 200 of inter-UE coordination implemented by a coordinating UE 30 (UE-A in the above examples). The coordinating UE 30 receives a reservation from a transmitting UE 30 of a first resource for a data transmission (block 205). The coordinating UE 30 determines that there is a conflict with the first resource (block 210). Responsive to the determining, the coordinating UE 30 sends control information to the transmitting UE 30 indicating one or more resources relevant for resource selection (block 215).

In some embodiments, the control message indicates alternative resources for the data transmission from which the transmitting UE 30 may select a second resource for the data transmission. The alternative resources may overlap with resources indicated in the first control message or may represent all new resources. In other embodiments, the control message indicates non-preferred/non-allowed resources for the data transmission. In this case, the transmitting UE 30 may select a resource indicated in the first control message as the second resource. Also, the transmitting UE may select a resource in a control message from a different coordinating UE as the second resource.

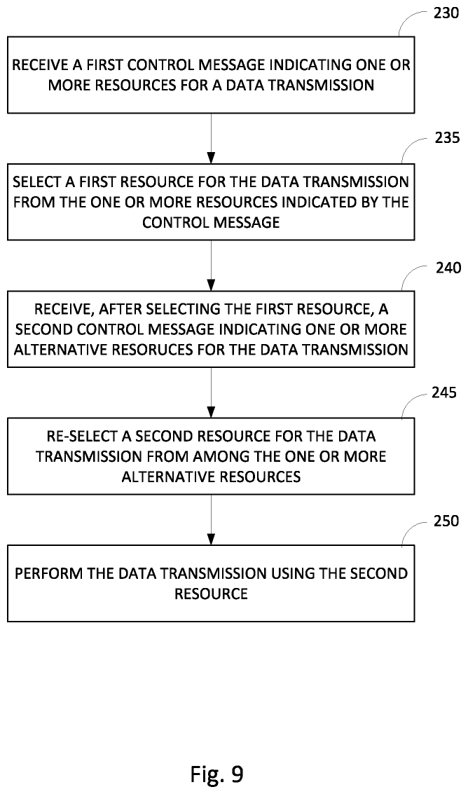

FIG. 9 illustrates an exemplary method 225 of inter-UE coordination implemented by a transmitting UE 30 (UE-B in the above examples). The transmitting UE 30 receives a control message indicating one or more resources for a data transmission and selects a first resource from among the one or more resources indicated by the control message (blocks 230. 235). After selecting the first resource, The transmitting UE 30 receives a second control message indicating one or more alternative resources for a data transmission (block 240). Responsive to the control message, the transmitting UE 30 re-selects a second resource from the one or more alternative resources for the data transmission and performs the data transmission using the second resource (blocks 245, 250).

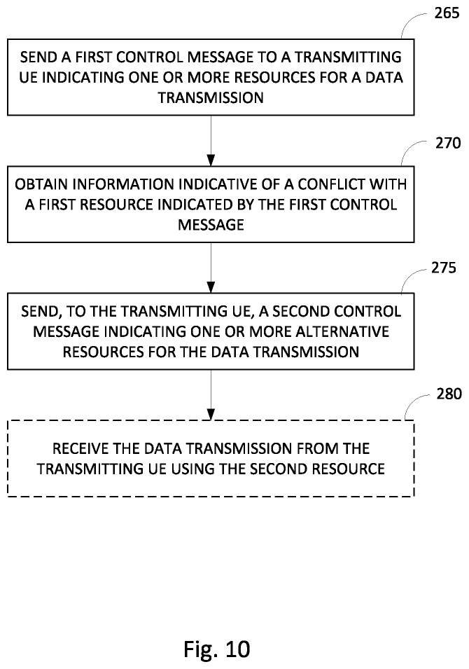

FIG. 10 illustrates an exemplary method 260 of inter-UE coordination implemented by a coordinating UE 30 (UE-A in the above examples). The coordinating UE 30 sends, to a transmitting UE, a first control message indicating one or more resources for a data transmission (block 265). After transmitting the first control message, the coordinating UE 30 obtains additional information indicative of a conflict with a first resource (block 270). Responsive to the obtaining, the coordinating UE 30 sends a second control message indicating one or more alternative resources for the data transmission to the transmitting UE 30 (block 275). In some embodiments, the coordinating UE 30 subsequently receives the data transmission from the transmitting UE 30 using a second resource selected from the alternative resources (block 280).

An apparatus can perform any of the methods herein described by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

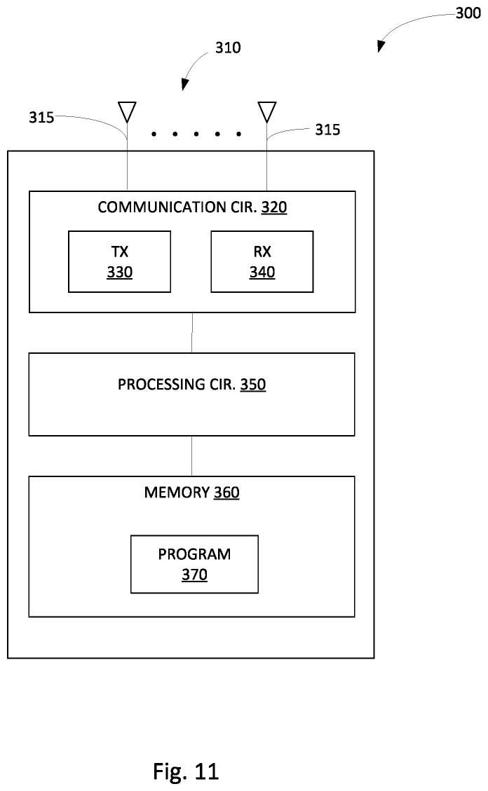

FIG. 11 illustrates a UE 300 according to another embodiment. The UE 300 comprises an antenna array 310 having one or multiple antennas 315, communication circuitry 320, processing circuitry 350, and memory 360.

The communication circuitry 320 is coupled to the antennas 310 and comprises the radio frequency (RF) circuitry needed for transmitting and receiving signals over a wireless communication channel. The RF circuitry may, for example, comprise a transmitter (TX) 330 and receiver (RX) 340 configured to operate according to the NR standard.

The processing circuitry 350 controls the overall operation of the UE 30 300 according to program instructions stored in memory 360. The processing circuitry 350 may comprise one or more microprocessors, hardware, firmware, or a combination thereof.

Memory 360 comprises both volatile and non-volatile memory for storing computer program code and data needed by the processing circuitry 350 for operation. Memory 360 may comprise any tangible, non-transitory computer-readable storage medium for storing data including electronic, magnetic, optical, electromagnetic, or semiconductor data storage. Memory 360 stores a computer program 370 comprising executable instructions that configure the processing circuitry 350 to implement one or more of the methods 100, 150, 200, 225 and 230 according to FIGS. 6-10 respectively. A computer program 370 in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 350 for configuring the processing circuitry 350 as herein described may be stored in a removable memory, such as a portable compact disc, portable digital video disc, or other removable media. The computer program 370 may also be embodied in a carrier such as an electronic signal, optical signal, radio signal, or computer readable storage medium.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

The techniques herein described combine inter-UE coordination and additional sensing information. The sensing information and inter-UE coordination information may have different origins or may be available at different times.

### Embodiments

1. A method implemented by a transmitting user equipment (UE) configured for device-to-device (D2D) communication, the method comprising:
receiving a control message from a coordinating UE indicating one or more resources for a data transmission, wherein the one or more resources include a first resource;
selecting the first resource for the data transmission;
obtaining additional information indicative of a conflict with the first resource;
re-selecting a second resource for the data transmission; and
performing the data transmission using the second resource.

2. The method according to embodiment 1, wherein the control message comprises a set of resources, preferably a set of non-preferred or preferred resources.

3. The method of embodiment 1 or 2, wherein the transmitting UE receives control messages from multiple coordinating UEs and selects a resource indicated in one of the control messages.

4. The method of embodiment 3, wherein selecting a first resource comprises selecting a resource which is common in all the received control messages.

5. The method of embodiment 3, wherein selecting a first resource comprises selecting a resource that is common to the maximum number of the received control messages.

6. The method of embodiment 3, wherein selecting a first resource comprises selecting a resource randomly among one of the received control messages.

7. The method of embodiment 3, wherein selecting a first resource comprises selecting a resource indicated in the latest of all the received control messages.

8. The method of embodiment 3, wherein selecting a first resource comprises selecting a resource based at least in part on the priorities of the coordinating UEs from which the control messages are received.

9. The method of embodiment 3, wherein selecting a first resource comprises selecting based at least in part on a previous request sent by the transmitting UE to one of the coordinating UEs.

10. The method of any one of embodiments 1-9, wherein obtaining additional information indicative of a conflict with the first resource comprises obtaining the additional information by monitoring slots belonging to a sidelink resource pool.

11. The method of embodiment 10, wherein obtaining additional information indicative of a conflict with the first resource comprises performing measurements to obtain the additional information.

12. The method of any one of embodiments 1-10, wherein obtaining additional information indicative of a conflict with the first resource comprises receiving control information transmitted by another UE.

13. The method of embodiment 12, wherein the control information comprises a set of resources, preferably a set of non-preferred or preferred resources.

14. The method of embodiment 12, wherein the control information comprises a reservation.

15. The method of embodiment 1-14, wherein the first resource is a resource reserved by the transmitting UE.

16. The method of any one of embodiments 1-14, wherein the first resource is a resource that is not reserved by the transmitting UE.

17. The method of embodiment 1 or 16, further comprising reporting the re-selection of the second resource to higher layer protocols.

18. The method of any one of embodiments 1-17, wherein the additional information is indicative of a collision with a resource reserved by another transmitting UE.

19. The method of any one of embodiments 1-17, wherein the additional information is indicative a half-duplex conflict.

20. The method of any one of embodiment 1-19, further comprising excluding the first resource after obtaining the additional information.

21. The method of embodiment 20 further comprising transmitting control information responsive to excluding the first resource.

22. The method of embodiment 21, wherein the control information comprises an indication that the transmitting UE dropped the first resource.

23. The method of embodiment 21, wherein the control information comprises a request for alternative resources to the coordinating UE.

24. The method of embodiment 23, wherein re-selecting the second resources comprises re-reselecting the second resource from alternative resources indicated in a control message received responsive to the request.

25. The method of any one of embodiments 1-24, wherein re-selecting the second resources comprises re-selecting the second resource from alternative resources indicated in a second control message received from a different UE than the first control message.

26. The method of any one of embodiments 1-24, wherein re-selecting the second resources comprises re-selecting the second resource from alternative resources indicated in a second control message received from the same coordinating UE at a different point in time as the first control message.

27. The method of any one of embodiment 1-22, wherein the transmitting UE re-selects the second resource based on its own sensing information.

28. The method of any one of embodiment 1-22, wherein the transmitting UE re-selects the second resource based on its own sensing information and an inter-UE coordination message received from another UE.

29. The method of any one of embodiments 1-28, wherein the data transmission includes a reservation for a future data transmission.

30. The method of any one of embodiments 1-29 wherein the control message comprises one of physical layer signaling, a Medium Access Control-Control Element (MAC-CE), or Radio Resource Control (RRC) signaling.

31. A method implemented by a transmitting user equipment (UE) configured for device-to-device (D2D) communication, the method comprising:
selecting a first resource for a data transmission;
transmitting a reservation message reserving the first resource for the data transmission;
receiving, after the transmission of the reservation, a control message from a coordinating UE indicating one or more resources relevant for resource selection;
responsive to the control message, selecting a second resource for the data transmission; and
performing the data transmission using the second resource.

32. The method of embodiment 31, wherein the reservation message further comprises a mode indication indicative of a first mode of resource selection for selecting the first resource.

33. The method of embodiment 32, wherein the mode indication comprises an indication that the resource selection mode for selecting the first resource used a reduced amount of sensing results.

34. The method of embodiment 32, wherein the mode indication comprises an indication that full sensing-based resource selection was used for selecting the first resource.

35. The method of any one of embodiments 31-34, wherein the control message comprises one of physical layer signaling, a Medium Access Control-Control Element (MAC-CE), or Radio Resource Control (RRC) signaling.

36. The method of any one of embodiments 31-34, wherein the control message comprises a set of resources, preferably a set of non-preferred or preferred resources.

37. The method of any one of embodiments 31-34, wherein the control message comprises one or more alternative resources for the data transmission and the transmitting UE selects the second resource from the alternative resources indicated in the control message.

38. The method of any one of embodiments 31-34, wherein the wherein the control message comprises one or more non-preferred or disallowed resources and the transmitting UE selects, as the second resource, a resource not indicated in the control message.

39. A method implemented by a coordinating user equipment (UE) configured for device-to-device (D2D) communication, the method comprising:
receiving a reservation from a transmitting UE of a first resource for a data transmission;
determining that there is a conflict with the first resource;
responsive to the determining, sending control information to the transmitting UE, the control information indicating one or more resources relevant for resource selection.

40. The method of embodiment 39, wherein the reservation comprises a mode indication indicative of a first mode of resource selection for selecting the first resource.

41. The method of embodiment 40, wherein the mode indication comprises an indication that the resource selection mode for selecting the first resource used a reduced amount of sensing results.

42. The method of embodiment 39, wherein the mode indication comprises an indication that full sensing-based resource selection was used for selecting the first resource.

43. The method of any one of embodiments 39-42, wherein the control message comprises one of physical layer signaling, a Medium Access Control-Control Element (MAC-CE), or Radio Resource Control (RRC) signaling.

44. The method of embodiment 39-42, wherein the control message comprises a set of resources, preferably a set of non-preferred or preferred resources.

45. The method of any one of embodiments 39-44, wherein the control message comprises one or more alternative resources for the data transmission and the transmitting UE selects the second resource from the alternative resources indicated in the control message.

46. The method of any one of embodiments 39-45, wherein the wherein the control message comprises one or more non-preferred or disallowed resources and the transmitting UE selects, as the second resource, a resource not indicated in the control message.

47. A method implemented by a transmitting user equipment (UE) configured for device-to-device (D2D) communication, the method comprising:
receiving a control message indicating one or more resources for a data transmission;
selecting a first resource from among the one or more resources indicated by the control message;
receiving, after selecting the first resource, a second control message indicating one or more alternative resources for a data transmission;
re-selecting a second resource from the one or more alternative resources for the data transmission; and
performing the data transmission using the second resource.

48. The method of embodiment 47, wherein the second control message includes resources indicated in the first control message.

49. A method implemented by a coordinating user equipment (UE) configured for device-to-device (D2D) communication, the method comprising:
sending, to a transmitting UE, a first control message indicating one or more resources for a data transmission;
obtaining additional information indicative of a conflict with a first resource among the one or more resources indicated by the first control message; and
sending, to the transmitting UE responsive to the obtaining, a second control message indicating a second resource for the data transmission.

50. The method of embodiment 49, wherein the second control message includes resources indicated in the first control message.

51. The method of embodiment 49 or 50, wherein the additional information is obtained by the coordinating UE by means of sensing.

52. The method of embodiment 49 or 50, wherein the additional information is obtained by the coordinating UE in a grant from another UE.

53. The method of embodiment 49 or 50, wherein the additional information is obtained by the coordinating UE in a reservation from another UE.

54 The method of embodiment 49 or 50, wherein obtaining the additional information comprises performing physical layer measurements.

55. A transmitting user equipment (UE) configured for device-to-device (D2D) communication, the UE being configured to:
receive a control message from a coordinating UE indicating one or more resources for a data transmission, wherein the one or more resources include a first resource;
select the first resource for the data transmission;
obtain additional information indicative of a conflict with the first resource;
re-select a second resource for the data transmission; and
perform the data transmission using the second resource.

56. The transmitting UE of embodiment 55, further configured to perform the method of any one of claims 2-30.

57. A transmitting user equipment (UE) configured for device-to-device (D2D) communication, the UE comprising:
communication circuitry configured for sidelink communication with other UEs;
processing circuitry configured to:
   receive a control message from a coordinating UE indicating one or more resources for a data transmission, wherein the one or more resources include a first resource;
   select the first resource for the data transmission;
   obtain additional information indicative of a conflict with the first resource;
   re-select a second resource for the data transmission; and
   perform the data transmission using the second resource.

58. The transmitting UE of embodiment 57, wherein the processing circuit is further configured to perform the method of any one of claims 2-30.

59. A transmitting user equipment (UE) configured for device-to-device (D2D) communication, the UE being configured to:
select a first resource for a data transmission;
transmit a reservation message reserving the first resource for the data transmission;
receive, after the transmission of the reservation, a control message from a coordinating UE indicating one or more resources relevant for resource selection;
responsive to the control message, select a second resource for the data transmission; and
perform the data transmission using the second resource.

60. The transmitting UE of embodiment 59, further configured to perform the method of any one of claims 32-38.

61. A transmitting user equipment (UE) configured for device-to-device (D2D) communication, the UE comprising:
communication circuitry configured for sidelink communication with other UEs;
processing circuitry configured to:
   select a first resource for a data transmission;
   transmit a reservation message reserving the first resource for the data transmission;
   receive, after the transmission of the reservation, a control message from a coordinating UE indicating one or more resources relevant for resource selection;
   responsive to the control message, select a second resource for the data transmission; and
   perform the data transmission using the second resource.

62. The transmitting UE of embodiment 61, wherein the processing circuit is further configured to perform the method of any one of claims 32-38.

63. A coordinating user equipment (UE) configured for device-to-device (D2D) communication, the UE being configured to:
receive a reservation from a transmitting UE of a first resource for a data transmission;
determine that there is a conflict with the first resource;
responsive to the determining, send control information to the transmitting UE, the control information indicating one or more resources relevant for resource selection.

64. The coordinating UE of embodiment 63, further configured to perform the method of any one of claims 40-46.

65. A coordinating user equipment (UE) configured for device-to-device (D2D) communication, the UE comprising:
communication circuitry configured for sidelink communication with other UEs;
processing circuitry configured to:
   receive a reservation from a transmitting UE of a first resource for a data transmission;
   determine that there is a conflict with the first resource;
   responsive to the determining, send control information to the transmitting UE, the control information indicating one or more resources relevant for resource selection.

66. The coordinating UE of embodiment 65, wherein the processing circuit is further configured to perform the method of any one of claims 40-46.

67. A transmitting user equipment (UE) configured for device-to-device (D2D) communication, the UE being configured to:
receive a control message indicating one or more resources for a data transmission;
select a first resource from among the one or more resources indicated by the control message;
receive, after selecting the first resource, a second control message indicating one or more alternative resources for a data transmission;
re-select a second resource from the one or more alternative resources for the data transmission; and
perform the data transmission using the second resource.

68. The transmitting UE of embodiment 67, further configured to perform the method of claim 48.

69. A transmitting user equipment (UE) configured for device-to-device (D2D) communication, the UE comprising:
communication circuitry configured for sidelink communication with other UEs;
processing circuitry configured to:
   receive a control message indicating one or more resources for a data transmission;
   select a first resource from among the one or more resources indicated by the control message;
   receive, after selecting the first resource, a second control message indicating one or more alternative resources for a data transmission;
   re-select a second resource from the one or more alternative resources for the data transmission; and
   perform the data transmission using the second resource.

70. The transmitting UE of embodiment 69, wherein the processing circuit is further configured to perform the method of claim 48.

71. A coordinating user equipment (UE) configured for device-to-device (D2D) communication, the UE being configured to:
send, to a transmitting UE, a first control message indicating one or more resources for a data transmission;
obtain additional information indicative of a conflict with a first resource among the one or more resources indicated by the first control message; and
send, to the transmitting UE responsive to the obtaining, a second control message indicating a second resource for the data transmission.

72. The coordinating UE of embodiment 71, further configured to perform the method of any one of claims 50-54.

73. A coordinating user equipment (UE) configured for device-to-device (D2D) communication, the UE comprising:
communication circuitry configured for sidelink communication with other UEs; processing circuitry configured to:
   send, to a transmitting UE, a first control message indicating one or more resources for a data transmission;
   obtain additional information indicative of a conflict with a first resource among the one or more resources indicated by the first control message; and
   send, to the transmitting UE responsive to the obtaining, a second control message indicating a second resource for the data transmission.

74. The coordinating UE of embodiment 73, wherein the processing circuit is further configured to perform the method of any one of claims 50-54.

75. A computer program comprising executable instructions that, when executed by a processing circuit in a user equipment in a wireless communication network, causes the user equipment to perform the method of any one of claims 1-54.

76. A carrier containing a computer program of claim 75, wherein the carrier is one of an electronic signal, optical signal, radio signal, or computer readable storage medium.

1-36. (canceled)

37. A method implemented by a transmitting user equipment (UE), configured for device-to-device, D2D, communication in a wireless communication network, wherein the transmitting UE is arranged to autonomously select resources for transmitting data over a D2D communication link, the method comprising:
receiving, by the transmitting UE, from a coordinating UE, a first control message using inter-UE coordination, the first control message comprising an indication of resources available for a data transmission;
selecting, by the transmitting UE based on the indication of available resources, a first resource for transmitting data over the D2D communication link to the coordinating UE;
prior to transmitting said data over the D2D communication link to the coordinating UE, excluding, by the transmitting UE, the selected first resource based on at least one of:
obtaining, by the transmitting UE, additional information indicative of a conflict with the first resource; and
receiving, by the transmitting UE, from the coordinating UE, a control message comprising updated resources;
subsequent to said excluding, re-selecting, by the transmitting UE, a second resource for transmitting said data over the D2D communication link to said coordinating UE; and
performing, by the transmitting UE, said transmitting of said data using said second resource.

38. The method in accordance with claim 37, wherein the indication of resources available for the data transmission comprises one of:
one or more allowed resources for the data transmission; and
one or more non-preferred or disallowed resources.

39. The method of claim 37, wherein the transmitting UE receives control messages from multiple coordinating UEs and selects a resource indicated in one of the control messages as the first resource, and wherein said step of selecting the first resource comprises any of:
selecting a resource which is common in all the received control messages;
selecting a resource that is common to a maximum number of the received control messages;
selecting a resource randomly among one of the received control messages;
selecting a resource indicated in a latest of the received control messages;
selecting a resource based at least in part on priorities of the coordinating UEs from which the control messages are received; and
selecting a resource based at least in part on a previous request sent by the transmitting UE to one of the coordinating UEs.

40. The method of claim 37, wherein obtaining additional information indicative of said conflict with the first resource comprises obtaining the additional information by monitoring slots belonging to a sidelink resource pool.

41. The method in accordance with claim 40, wherein said obtaining additional information indicative of said conflict with the first resource comprises any of:
performing measurements to obtain the additional information; and
receiving control information transmitted by another UE in said wireless communication network, wherein said control information is a grant or a reservation.

42. The method of claim 37, further comprising:
transmitting, by the transmitting UE, control information responsive to excluding the first resource, wherein the control information comprises any of:
an indication that the transmitting UE excluded the first resource; and
a request for alternative resources to a coordinating UE.

43. The method in accordance with claim 42, wherein re-selecting comprises re-selecting the second resources from alternative resources indicated in an additional control message received responsive to said request for alternative resources.

44. The method of claim 37, wherein the step of re-selecting the second resource comprises any of:
re-selecting the second resource from alternative resources indicated in a second control message received from a different UE than the first control message; and
re-selecting the second resource from alternative resources indicated in a second control message received from the same coordinating UE at a different point in time as the first control message.

45. The method of claim 14, wherein the second control messages comprise:
one or more alternative resources for transmitting of said data, and wherein the transmitting UE selects the second resource from the alternative resources indicated in the control message; and
one or more non-preferred or disallowed resources, and wherein the transmitting UE selects, as the second resource, a resource not indicated in the control message.

46. The method of claim 37, further comprising:
prior to the step of excluding, transmitting, by the transmitting UE, a reservation message reserving the first resource for transmitting data over the D2D communication link.

47. The method of claim 37, wherein re-selecting comprises reselecting said second resource among said updated resources in said control message from said coordinating UE.

48. A method implemented by a coordinating user equipment (UE), configured for device-to-device (D2D), communication with a transmitting UE in a wireless communication network, wherein the transmitting UE is arranged to autonomously select resources for transmitting data over a D2D communication link, the method comprising:
determining, by the coordinating UE, that said transmitting UE is to use a resource for transmitting data over the D2D communication link to the coordinating UE;
prior to receiving said data over the D2D communication link from the transmitting UE, determining, by the coordinating UE, that there is a conflict with said resource for transmitting data; and
responsive to said determining, sending, by the coordinating UE, control information to the transmitting UE, wherein the control information indicates one or more resources relevant for resource re-selection by said transmitting UE.

49. The method in accordance with claim 48, wherein said step of determining that said transmitting UE is to use a resource for transmitting data comprises:
receiving, by the coordinating UE, a reservation from the transmitting UE of a first resource for said transmitting data.

50. The method in accordance with claim 49, wherein the reservation comprises a mode indication indicative of a first mode of resource selection for selecting the first resource, and wherein the mode indication comprises any of:
an indication that the resource selection mode for selecting the first resource used a reduced amount of sensing results; and
an indication that full sensing-based resource selection was used for selecting the first resource.

51. The method in accordance with claim 48, wherein the step of determining that said transmitting UE is to use a resource for transmitting data comprises:
sending, to the transmitting UE, a first control message indicating one or more resources for said transmitting data.

52. The method in accordance with claim 48, wherein said step of sending comprises:
sending, to the transmitting UE, a second control message indicating a second resource for said transmitting data.

53. The method in accordance with claim 48, wherein said step of determining that there is a conflict with said resource for transmitting data comprises obtaining additional information, wherein the additional information is obtained by any of:
the coordinating UE by means of sensing;
the coordinating UE in a grant from another UE;
the coordinating UE by receiving a resource set from other UE;
the coordinating UE in a reservation from another UE; and
physical layer measurements.

54. A transmitting user equipment (UE) configured for device-to-device (D2D) communication in a wireless communication network, the transmitting UE comprising:
communication circuitry for communicating with other UEs; and
processing circuitry operatively connected to the communication circuitry and configured to:
receive, by the transmitting UE, from a coordinating UE, a control message using inter-UE coordination, the control message comprising an indication of a first resource;
select, by the transmitting UE, the first resource for transmitting data over the D2D communication link to the coordinating UE;
prior to transmitting said data over the D2D communication link to the coordinating UE, exclude, by the transmitting UE, the selected first resource based on at least one of:
obtain, by the transmitting UE, additional information indicative of a conflict with the first resource; and
receive, by the transmitting UE, from the coordinating UE, a control message comprising updated resources;
subsequent to said excluding, re-select, by the transmitting UE, a second resource for transmitting said data over the D2D communication link to said coordinating UE; and
perform, by the transmitting UE, said transmitting of said data using said second resource.

55. A coordinating user equipment (UE) configured for device-to-device (D2D) communication with a transmitting UE in a wireless communication network communication circuitry for communicating with other UEs; and
processing circuitry operatively connected to the communication circuitry and configured to:
determine, by the coordinating UE, that said transmitting UE is to use a resource for transmitting data over the D2D communication link to the coordinating UE;
prior to receiving said data over the D2D communication link from the transmit UE, determining, by the coordinating UE, that there is a conflict with said resource for transmitting data; and
responsive to said determining, send, by the coordinating UE, control information to the transmitting UE, wherein the control information indicates one or more resources relevant for resource re-selection by said transmitting UE.
